(19) United States
(12) Patent Application Publication
(10) Pub. No.: US 2012/0258435 A1
(43) Pub. Date: Oct. 11, 2012

(54) METHOD FOR CONDUCTING AN ASSESSMENT AND A PARTICIPANT RESPONSE SYSTEM EMPLOYING THE SAME

(75) Inventors: Kimberly Eleanor Tee, Calgary (CA); Ping-Kwan Lai, Calgary (CA); Lucien W. Dupont, San Diego, CA (US); Colin Dere, Calgary (CA); David Labine, Calgary (CA)

(73) Assignee: SMART TECHNOLOGIES ULC, Calgary (CA)

(21) Appl. No.: 13/436,668

(22) Filed: Mar. 30, 2012

Related U.S. Application Data
(60) Provisional application No. 61/472,180, filed on Apr. 5, 2011.

(51) Int. Cl. G09B 7/00

(52) U.S. Cl. 434/336; 434/353

(57) ABSTRACT

A computerized method comprises creating an answer key for an assessment comprising one or more questions to be delivered to one or more participants, where the answer key comprises assessment information and question information; delivering the assessment to the participants; collecting responses from the participants; and saving question descriptions, any annotations made thereon and the collected responses.

### CROSS-REFERENCE TO RELATED APPLICATIONS

This application claims the benefit of U.S. Provisional Application No. 61/472,180 to Tee, et al. filed on Apr. 5, 2011, entitled “METHOD FOR CONDUCTING AN ASSESSMENT AND A PARTICIPANT RESPONSE SYSTEM EMPLOYING THE SAME”, the content of which is incorporated herein by reference in its entirety.

### FIELD OF THE INVENTION

The present invention relates generally to participant response systems and in particular, to a method for conducting an assessment and a participant response system employing the same.

### BACKGROUND OF THE INVENTION

Participant response systems for enabling participants of an event to enter responses to posed questions, motions or the like are well known in the art and have wide applicability. For example, during a conference, seminar or the like, participants can be provided with handsets that enable the participants to respond to questions, or to vote on motions raised during the conference or seminar. In the entertainment field, audience members can be provided with handsets that enable the audience members to vote for entertainment programmes or sports events. These participant response systems are also applicable in the field of education. Participants can be provided with handsets that enable the participants to respond to questions posed during lessons, tests or quizzes. Of significant advantage, these participant response systems provide immediate feedback to presenters, teachers, entertainment programme producers, or event organizers. With respect to the field of education, research shows that teachers teach and participants learn more effectively when there is rapid feedback concerning the state of participants' comprehension or understanding. It is therefore not surprising that such participant response systems are gaining wide acceptance in the field of education.

Participant response systems fall generally into two categories, namely wired and wireless participant response systems. In wired participant response systems, participants respond to posed questions or vote on motions using remote units that are physically connected to a local area network and communicate with a base or host general purpose computing device over wired links. In wireless participant response systems, the remote units communicate with the base or host general purpose computing device wirelessly.

A number of different wired and wireless participant response systems have been considered. For example, U.S. Pat. No. 4,247,908 to Lockhart, Jr., et al. discloses a two-way communication system for use with a host computer that includes a control unit, a base station and multiple, hand-held, portable radio/data terminal units. The control unit interfaces directly with the host computer but uses a radio link to interface with the portable radio/data terminal units. Each portable radio/data terminal unit includes a two-way radio and a data terminal. The data terminal includes a keyboard for data entry and an LED display for readout of either received data or locally generated data. The host computer initiates communication through polling and/or selection of portable radio/data terminal units via the control unit. The control unit, in response to a “poll” from the host computer, responds by sending either a previously received message from a portable radio/data terminal unit, or if no message has been received, a “no message” response. Polling by the control unit is an invitation to the portable radio/data terminal units to send data to the control unit to be stored, grouped if necessary and sent on to the host computer. The control unit polls the portable radio/data terminal units by address in a particular sequence. The control unit transmits acknowledgements to the portable radio/data terminal units for received data on the next polling cycle.

U.S. Pat. No. 5,002,491 to Abrahamson, et al. discloses an interactive electronic classroom system for enabling facilitators to teach participants concepts and to receive immediate feedback regarding how well the participants have learned the taught concepts. Structure is provided for enabling participants to proceed in lockstep or at their own pace through exercises and quizzes, responding electronically to posed questions. The facilitator is able to receive the responses, and to interpret a readout, in histogram or other graphic display form, of the responses. The electronic classroom comprises a central computer and a plurality of participant computers, which range from simple devices to full fledged personal computers, connected to the central computer over a network. Optional peripheral hardware, such as video cassette recorders (VCRs) or other recording/reproducing devices, may be used to provide lessons to participants in association with the computer network.

U.S. Pat. No. 6,790,045 to Drimmer discloses a method and system for analyzing participant performance by classifying participant performance into discrete performance classifications associated with corresponding activities related to an electronic course. An observed participant performance level for at least one of the performance classifications is measured. A benchmark performance level or range is established for one or more of the performance classifications. It is then determined whether the observed participant performance level is compliant with the established benchmark performance level for the at least one performance classification. Instructive feedback is determined for the observed participant based upon any material deviation of the observed participant performance from at least one benchmark.

U.S. Patent Application Publication No. 2004/0072136 to Roschelle, et al. discloses a method and system for assessing a participant's understanding of a process that may unfold over time and space. The system comprises thin client devices in the form of wireless, hand-held, palm-sized computers that communicate with a host workstation. The system provides a sophisticated approach of directing participants to perform self-explanation, and enables instructors to enhance the value of this pedagogical process by providing meaningful and rapid feedback in a classroom setting.

U.S. Patent Application Publication No. 2004/0072497 to Buehler, et al. discloses a response system and method of retrieving user responses from a plurality of users. The response system comprises a plurality of base units and a plurality of response units. Each of the response units is adapted to receive a user input selection and to communicate that user's input selection with at least one base unit utilizing wireless communication. Personality data is provided for the response units to facilitate communication with a particular base unit. The personality data of a particular response unit is changed when it is desired to change the base unit to which that response unit communicates. This allows a response unit to become grouped with a particular base unit at a particular time and become grouped with another base unit at another particular time.

Although prior art participant response systems allow questionnaires or assessments to be administered to participants and the response data gathered, these participant response systems typically have limited functionalities. For example, in some situations, a facilitator may want to administer an assessment that is in a format (e.g., PEG or TIFF images, Portable Document Format (PDF) file, Microsoft® Word file, etc.) that is incompatible with the participant response system. In these cases, the facilitator must convert the assessment to a compatible format before the assessment can be delivered to participants. Conversion of the assessment typically must be performed manually, which is time consuming and a burden to the facilitator. Although certain techniques, e.g., optical character recognition (OCR), may be used to facilitate the conversion, such approaches are typically still time consuming. Alternatively, the participant response system can employ a file format convertor to convert an assessment file to a compatible format. However, the file formats that file format convertors are typically able to process are often limited. Additionally, file format convertors may be introduce errors into the converted assessment files, due to the complexity of the assessment content of the files to be converted. As will be appreciated, improvements are desired.

It is therefore an object of the present invention to provide a novel method for conducting an assessment and a novel participant response system employing the same.

### SUMMARY OF THE INVENTION

Accordingly, in one aspect there is provided a computerized method comprising: creating an answer key for an assessment comprising one or more questions to be delivered to one or more participants, the answer key comprising assessment information and question information; delivering the assessment to the participants; collecting responses from the participants; and saving question descriptions, any annotations made thereon and the collected responses.

In one embodiment, the assessment information comprises at least one of an assessment title, an assessment type, an assessment subject and an assessment topic. In this case, the creating comprises entering at least one of the assessment title, the assessment type, the assessment subject and the assessment topic.

In one embodiment, the question information comprises at least one of a question type, points, tags and a correct answer of each question in the assessment. In this case, the creating comprises entering at least one of the question type, the points, the tags and the correct answer for each question.

In one embodiment, the method further comprises deriving the question descriptions from at least one electronic document and displaying the question descriptions. The method may further comprise saving the created answer key as an XML description and attaching the at least one electronic document to the XML description. The method may further comprise overlaying a transparent layer configured to receive annotations over the displayed question descriptions.

According to another aspect, there is provided a response system comprising: a plurality of response devices; and processing structure communicating with the response devices and executing program code for conducting an assessment, the processing structure being configured to: create an answer key for the assessment, the answer key comprising assessment information and question information; deliver the contents of the assessment to response devices; receive responses from response devices; and cause question descriptions and any annotations thereon to be displayed.

According to yet another aspect, there is provided a non-transitory computer-readable medium storing computer executable instructions, which when executed by processing structure, cause an apparatus at least to create an answer key for an assessment comprising one or more questions to be delivered to one or more participants, the answer key comprising assessment information and question information; deliver the assessment to said participants; collect responses from said participants; and save question descriptions, any annotations made thereon and the collected responses.

### BRIEF DESCRIPTION OF THE DRAWINGS

Embodiments will now be described more fully with reference to the accompanying drawings in which:

FIG. 1 is a schematic plan view of a participant response system.

FIG. 2 is a partial perspective, schematic view of the participant response system of FIG. 1.

FIG. 3 is a perspective view of an interactive whiteboard forming part of the participant response system of FIG. 1.

FIG. 4 is a schematic view of a software architecture used by the participant response system of FIG. 1.

FIG. 5 is a participant response window presented by the participant response system of FIG. 1.

FIG. 6 is a management module window presented by the participant response system of FIG. 1.

FIG. 7 is a window presented by the participant response system of FIG. 1, showing a host-side application pop-up menu.

FIG. 8 is a schematic diagram showing a data structure used by the participant response system of FIG. 1.

FIG. 9 is a flowchart showing steps of a data management and assessment execution process used by the participant response system of FIG. 1.

FIG. 10 is a flowchart showing steps of an assessment set up process used by the participant response system of FIG. 1.

FIG. 11 is an assessment information entry window presented by the participant response system for FIG. 1.

FIG. 12 is an assessment question type selection window presented by the participant response system of FIG. 1.

FIG. 13A is an assessment question description entry window presented by the participant response system of FIG. 1.

FIG. 13B is a correct answer selection and points entry window presented by the participant response system of FIG. 1.

FIG. 14 is an assessment answer key creation without question description entry window presented by the participant response system of FIG. 1.

FIG. 15A is a flowchart showing steps of an assessment answer key creation without question description entry process used by the participant response system of FIG. 1.

FIG. 15B is a flowchart showing steps of an instant assessment answer key creation process used by the participant response system of FIG. 1.

FIG. 15C is a flowchart showing steps of a generic answer key creation process used by the participant response system of FIG. 1.

FIG. 16 is an exemplary XML description of an answer key used by the participant response system of FIG. 1.

FIG. 17A is a screenshot of an exemplary external file comprising a question description.

FIG. 17B is a screenshot of the exemplary external file of FIG. 17A, showing a transparent mode toolbar displayed thereon.

FIG. 17C is a screenshot of the exemplary external file of FIG. 17A, showing annotations using a transparent mode displayed thereon.

FIG. 18 is a flowchart showing steps of a process for conducting the assessment using the transparent mode, used by the participant response system of FIG. 1.

### DETAILED DESCRIPTION OF THE EMBODIMENTS

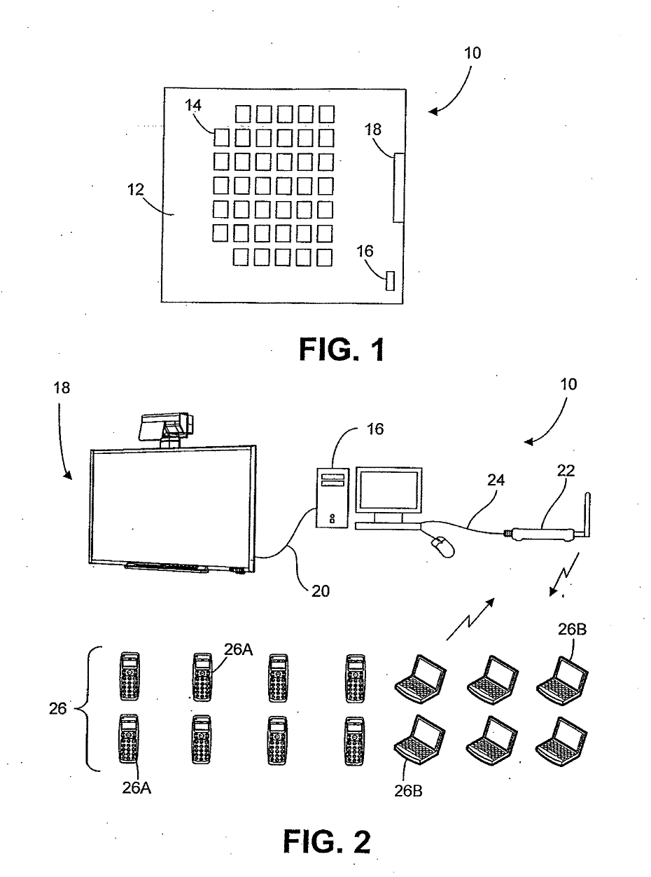

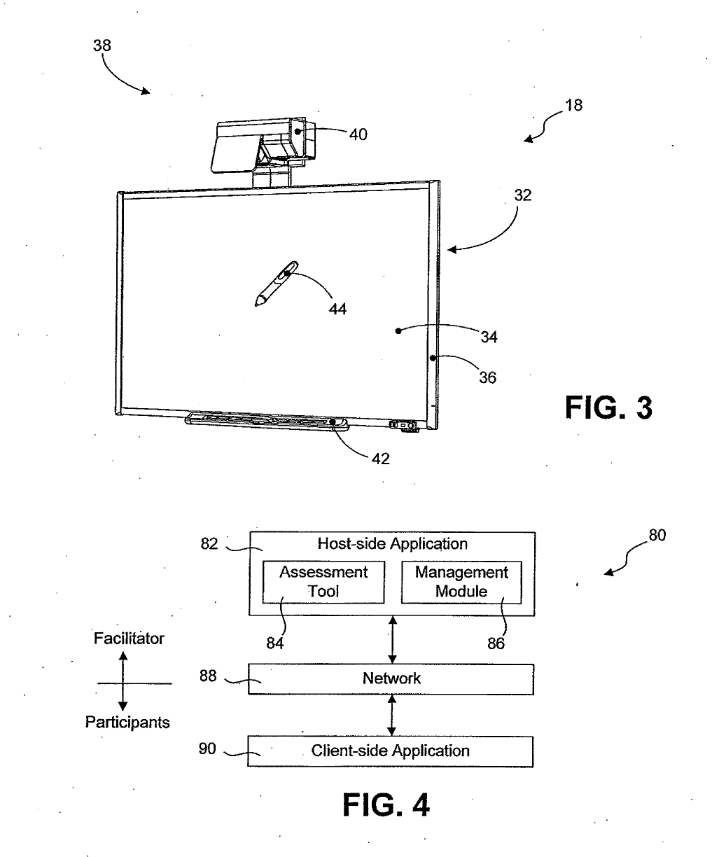

Turning now to FIGS. 1 and 2, a participant response system is shown and is generally identified by reference numeral 10. In this embodiment, participant response system 10 is employed in a room 12, e.g., a classroom, lecture hall or theatre of an educational institution such as for example a school, university, college or the like, having a plurality of seats 14. As can be seen, the participant response system 10 comprises a general purpose computing device 16, an interactive whiteboard (IWB) 18 physically connected to the general purpose computing device 16 via a cable 20, a radio frequency (RF) transceiver 22 physically connected to the general purpose computing device 16 via a universal serial bus (USB) cable 24, and a plurality of wireless, participant response devices 26 communicating with the general purpose computing device 16 via the transceiver 22. In the embodiment shown, the participant response devices 26 comprise remote units 26A and laptop computers 26B. Generally, each response device is assigned to a seat 14.

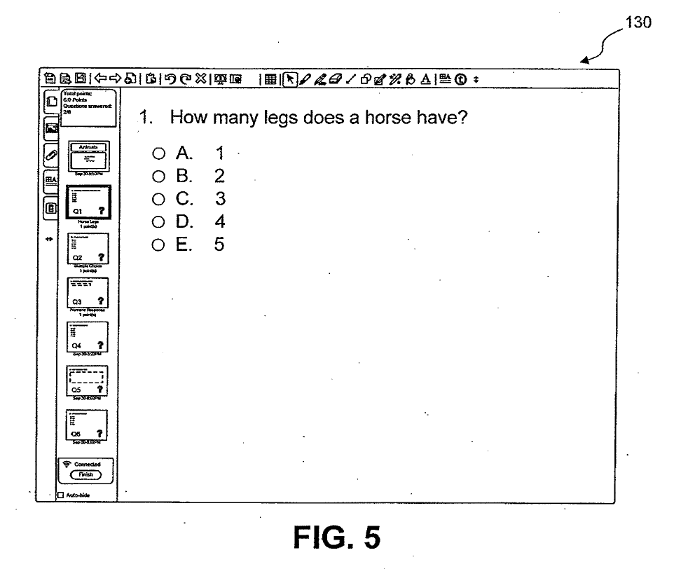

As is best seen in FIG. 3, IWB 18 is mounted on a vertical support surface such as for example, a wall surface or the like. IWB 18 comprises a generally planar, rectangular interactive surface 34 that is surrounded about its periphery by a bezel 36. An ultra-short-throw projector 40 such as that sold by SMART Technologies ULC of Calgary, Alberta, Canada, assignee of the subject application, under the name “SMART UX60”, is also mounted on the support surface above the IWB 18 and projects an image, such as for example, a computer desktop, onto the interactive surface 34.

The IWB 18 employs machine vision to detect one or more pointers brought into a region of interest in proximity with the interactive surface 34. The IWB 18 communicates with the computing device 16 executing one or more application programs via the USB cable 20. Computing device 16 processes the output of the IWB 18 and adjusts image data that is output to the projector 40, if required, so that the image presented on the interactive surface 34 reflects pointer activity. In this manner, the IWB 18, computing device 16 and projector 40 allow pointer activity proximate to the interactive surface 34 to be recorded as writing or drawing or used to control execution of one or more application programs executed by the computing device 16.

The bezel 36 in this embodiment is mechanically fastened to the interactive surface 34 and comprises four bezel segments that extend along the edges of the interactive surface 34. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces extend in a plane generally normal to the plane of the interactive surface 34.

A tool tray 42 is affixed to the IWB 18 adjacent the bottom bezel segment using suitable fasteners such as for example, screws, clips, adhesive, etc. As can be seen, the tool tray 42 comprises a housing having an upper surface configured to define a plurality of receptacles or slots. The receptacles are sized to receive one or more pen tools 44 as well as an eraser tool (not shown) that can be used to interact with the interactive surface 34. Control buttons (not shown) are provided on the upper surface of the housing to enable a user to control operation of the IWB 18. Further details of the tool tray 42 are provided in International PCT Application Publication No. WO 2011/085486 filed on Jan. 13, 2011 and entitled “INTERACTIVE INPUT SYSTEM AND TOOL TRAY THEREFOR”.

Imaging assemblies (not shown) are accommodated by the bezel 36, with each imaging assembly being positioned adjacent a different corner of the bezel. Each of the imaging assemblies has an infrared light source and an imaging sensor having an associated field of view. The imaging assemblies are oriented so that their fields of view overlap and look generally across the entire interactive surface 34. In this manner, any pointer such as for example a user's finger, a cylinder or other suitable object, or a pen or eraser tool lifted from a receptacle of the tool tray 42, that is brought into proximity of the interactive surface 34 appears in the fields of view of the imaging assemblies.

The computing device 16 in this embodiment is a personal computer or other suitable processing device or structure comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computing device 16 may also comprise networking capability using Ethernet, WiFi, and/or other network format, for connection to access shared or remote drives, one or more networked computers, or other networked devices.

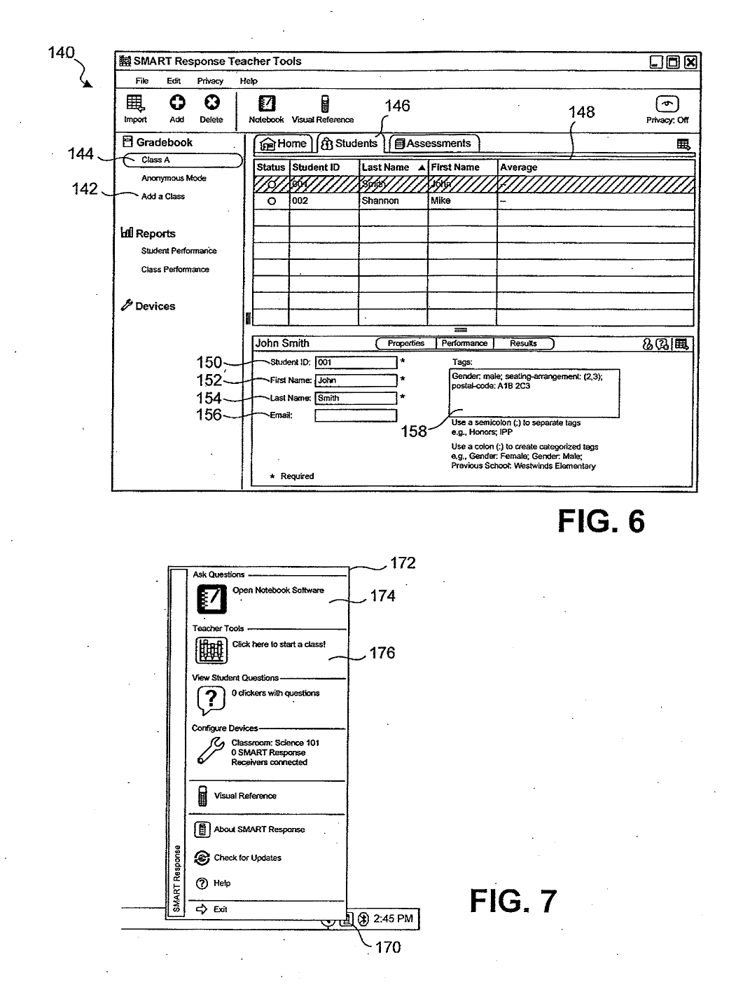

FIG. 4 shows the software architecture used by the participant response system 10, which is generally indicated by reference numeral 80. In this embodiment, software architecture 80 comprises a host-side application 82 running on the general purpose computing device 16. The host-side application 82 is in communication via a network 88 with one or more client-side applications 90 running on the response devices 26. The host-side application 82 provides functionality that enables assessments to be created, created assessments to be sent to the response devices 26, responses from the response devices 26 to be received and analyzed, and response data and analysis results to be presented.

The host and client-side applications are embodied in SMART Response™ PE software offered by SMART Technologies ULC. As is known, the host-side of SMART Response™ PE software comprises SMART Notebook™ software together with facilitator tools. The client-side applications 90 provide functionality that enables assessments to be displayed on response devices 26 and responses entered and transmitted. SMART Notebook™ provides a graphical user interface comprising a canvas page or palette on which freeform or handwritten ink objects together with other computer generated objects, mouse events and other commands can be input.

In the case of the remote units 26A, the client-side application 90 is implemented as firmware stored in the memory of each remote unit 26A, and is executed by the remote unit 26A when the remote unit 26A is booted up. Specifics of the remote units 26A are disclosed in International PCT Application Publication No. WO 2008/083486 entitled “PARTICIPANT RESPONSE SYSTEM EMPLOYING BATTERY POWERED, WIRELESS REMOTE UNITS” filed on Jan. 10, 2008, and assigned to SMART Technologies ULC, the content of which is incorporated herein by reference in its entirety.

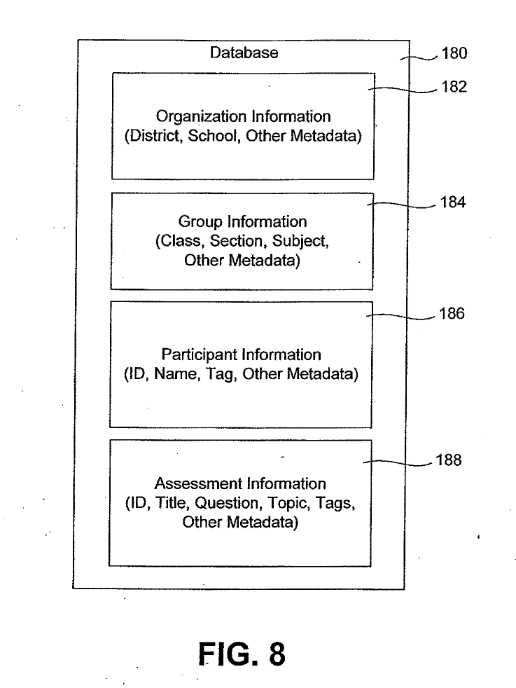

In the case of the laptop computers 26B, the client-side application 90 is also implemented as a software application running on each laptop computer 26B. For these implementations, the client-side application 90 presents a graphical user interface (GUI) window 130 that is configured to display questions and to receive responses as shown in FIG. 5. GUI window 130 is presented to participants during an assessment. The window 130 is implemented in SMART Notebook™ Student Edition software, offered by SMART Technologies ULC that is running on the portable computing devices 26B.

Referring again to FIG. 4, the host-side application 82 comprises an assessment tool 84 and a management module 86. When the assessment tool 84 is being employed, the GUI of the assessment tool 84 is output by the general purpose computing device 16 and conveyed to the IWB 18, which in turn is used by the projector 40 to display the GUI on the interactive surface 34. In this manner, the IWB 18 can be used by the facilitator to create and administer assessments and to analyze assessment results.

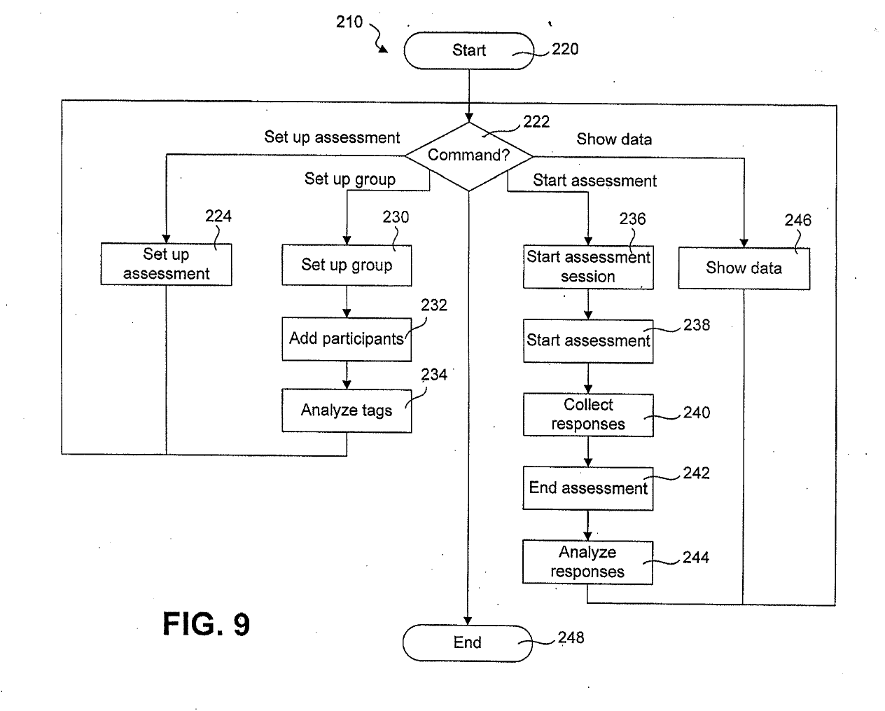

The management module 86 also comprises a GUI in the form of a management module window that is presented on the display screen of the general purpose computing device 16 (and/or optionally the interactive surface 34) when the management module 86 is being employed. The management module 86 provides a variety of functions selectable by the facilitator for generally managing participants, groups, response devices, and assessments. FIG. 6 shows the management module window, which is generally indicated by reference numeral 140. Management module window 140 comprises an add-group button 142 that may be selected to create a new participant group. In the embodiment shown, Add-group button 142 is labelled “Add a Class”. Management module window 140 also comprises a list 144 of groups, each of which may be selected for viewing or editing. In the embodiment shown, the list 144 comprises a single group “Class A”. Management module window 140 also comprises a participants tab 146 that may be selected to display a list 148 of participants of the group selected from group list 144. In the embodiment shown, participants tab 146 is labelled “Students”. Each of the participants in list 148 may be selected to view and edit additional information about that participant. In the embodiment shown, the additional information comprises student identification (ID) 150, First Name 152, Last Name 154, Email 156, and Tags 158.

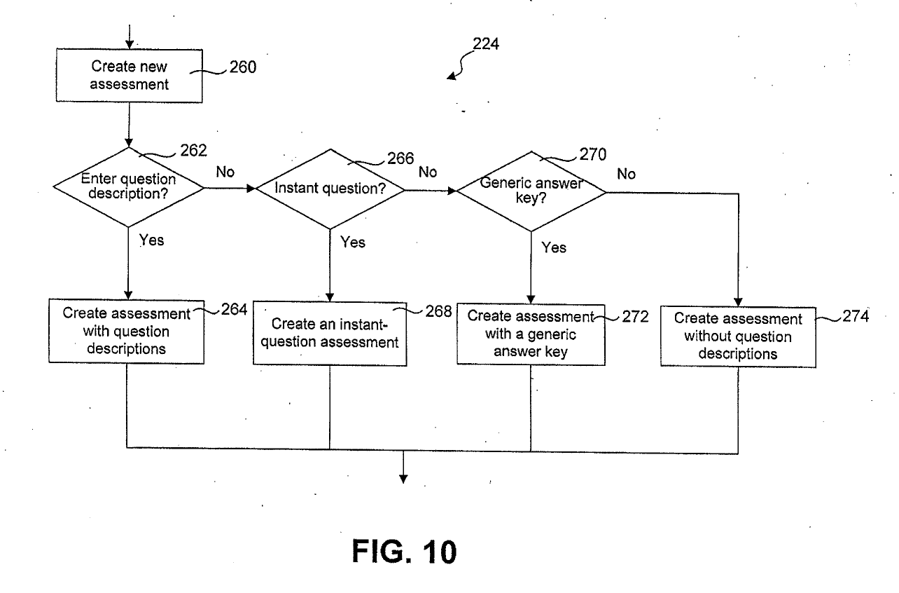

As described above, the host side application 82 runs on the general purpose computing device 16 which, in this embodiment, uses a Microsoft Windows® XP operating system. As shown in FIG. 7, a desktop icon 170 representing the host-side application 82 is displayed in the system tray of the Microsoft® Windows® XP operating system. Selecting the icon 170 displays a host-side application pop-up menu 172 for accessing the assessment tool 84 and the management module 86 of the participant response system 10. Host-side application pop-up menu 172 comprises an Ask Questions icon 174 that may be selected to launch the assessment tool 84. Host-side application pop-up menu 172 also comprises a Facilitator Tools icon 176 that may be selected to launch the management module 86 for managing participants and groups, and for viewing data.

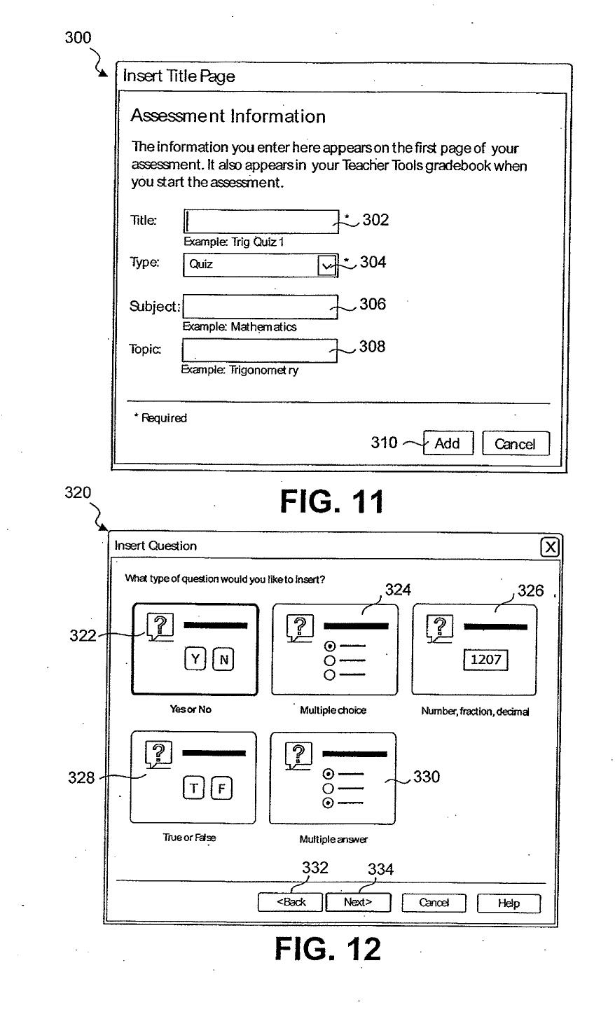

The management module 86 stores data of the participant response system 10 in a database 180. As shown in FIG. 8, the database 180 is configured to store data categorized as: organization information 182, which may for example comprise a school name, a school address, teacher identity ID information, teacher schedules, tags, etc.; group information 184, which may for example comprise the name, schedule, room number, the names of students of a class set up by the teacher, tags, etc.; participant information 186, which may for example comprise participant IDs, participant names, tags, etc.; and assessment information 188, which may for example comprise assessment IDs, titles, questions, topic, tags, etc. Each question has a composite data structure which comprises information such as the question's number, the type of the question, possible answer choices (in case of a multiple choice question), correct answer, points, description of the question or a link to a document containing the question description.

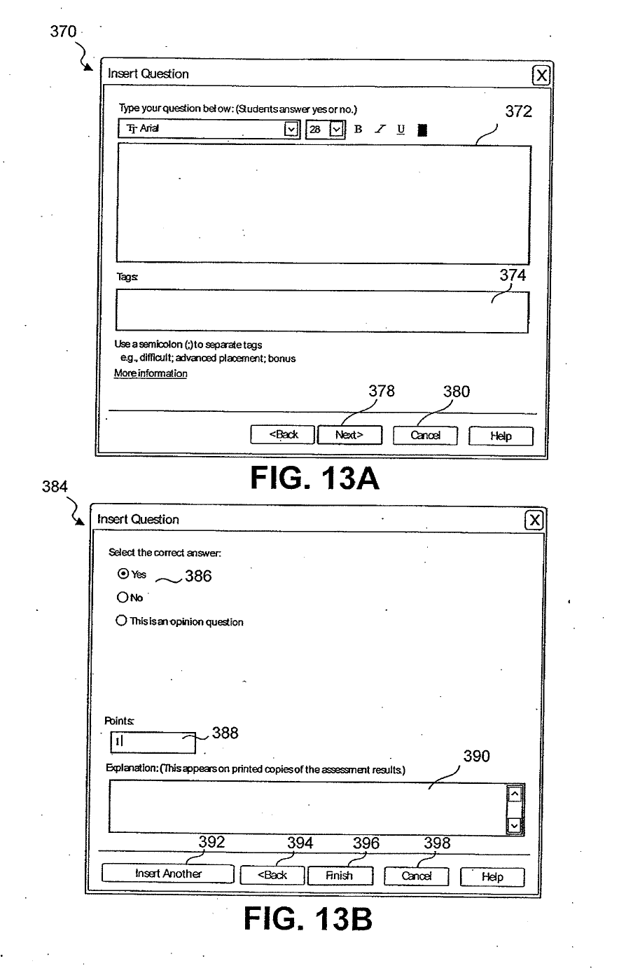

FIG. 9 shows a data management and assessment execution process performed by the host-side application 82, and which is generally referred to using reference numeral 210. The process 210 starts when the host-side application 82 starts to run on the general purpose computing device 16 (step 220). Once started, the desktop icon 170 representing the host-side application 82 is displayed in the system tray of the Microsoft® Windows® XP operating system, as shown in FIG. 7, and the process awaits input of a command from the facilitator (step 222). This input may be provided by the facilitator via the assessment tool 84 and/or the management module 86. If the facilitator enters a “set up assessment” command at step 222, the assessment tool 84 is launched, if not already open, for enabling the facilitator to create or edit an assessment (step 224), and the process loops back to step 222. In this embodiment, the assessment is a SMART Notebook™ document comprising one or more questions of any of a true/false type, a yes/no type, a multiple choice type, multiple answer type, a short answer type, and a numeric question type.

In this embodiment, the assessment tool 84 allows the facilitator to set up an assessment by creating an answer key for the assessment. The answer key comprises one or more questions of the assessment, assessment information and question information. The answer key may be created either by manually entering each question making up the assessment or by using question descriptions from another, separate electronic document of suitable format, such as for example, a PDF file, an image file, a text file, a Microsoft Office (e.g., Word, Excel or PowerPoint) file, an OpenOffice file, a webpage, or the like. The step of setting up an assessment (step 224) is further described herein.

If a “set up group” command is received at step 222, the management module 86 is launched, if not already open, for enabling the facilitator to set up a group (step 230). The facilitator may create a new group or edit an existing group, and may input or modify group information. The group information may comprise, for example, a name of a class, a class room number, names of students in the class, and a class schedule. Once a group has been set up, the facilitator may then add participants to the group (step 232). The facilitator may also input or modify participant information, such as for example student ID, student name, and tag strings. Once all participant information has been entered, the management module 86 then analyzes the tag strings (step 234). Following step 234, the data management process returns to step 222 to await input of a command.

If a “start assessment” command is received at step 222, an assessment session is then started and the assessment tool 84 is launched (step 236). Upon starting the assessment session (step 238), the questions of the assessment to be administered are transmitted to the response devices 26. As participants enter responses to the questions using the response devices 26, the responses are transmitted to the general purpose computing device 16 (step 240). When the assessment is finished, the facilitator ends the assessment (step 242). The general purpose computing device 16 then analyzes the received responses to determine response data, such as for example, whether or not participant responses are correct, participant scores for the assessment, and statistical results of the assessment that are automatically calculated after the assessment; etc. (step 244). Following step 244, the process returns to step 222 to await input of a command.

If a “show data” command generated in response to selection of a “show data” button (not shown) presented either by the assessment tool 84 or management module 86, is received at step 222, data selected by the facilitator is displayed on the display screen of the general purpose computing device 16 and/or interactive surface 34 (step 246). In the embodiment shown, the selected data comprises the response data analysis carried out at step 244. However, as will be understood, the selected data may be any data stored in the database 180 and selected by the facilitator for display. At this step, if the data selected for display is a statistical result that has not been calculated, the management module 86 calculates the statistical result and then shows it. Following step 246, the process returns to step 222 to await input of a command.

If a “quit” command is received at step 222, the process 210 ends (step 248).

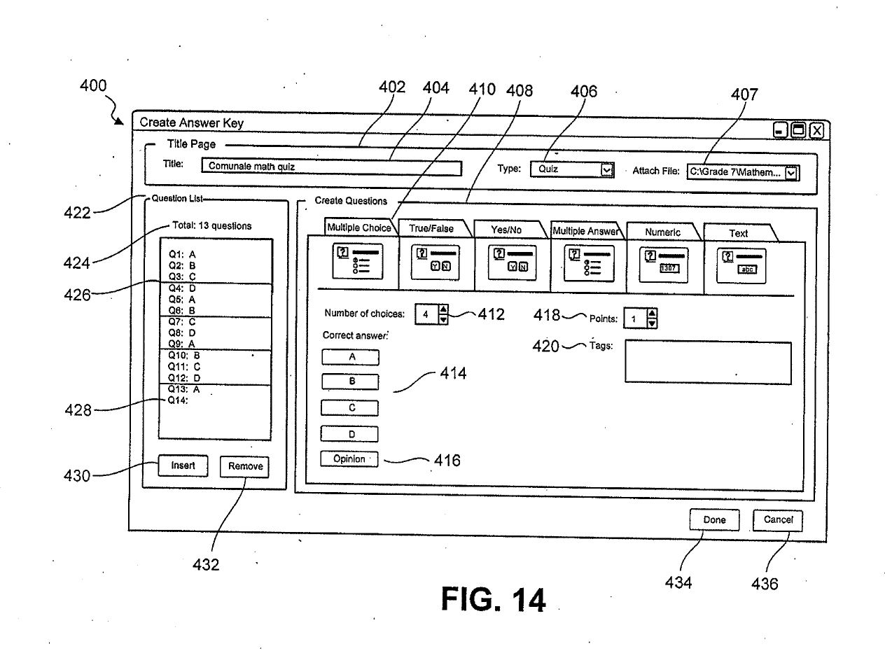

FIG. 10 shows an assessment set up process that is carried out during step 224 of process 210. As mentioned above, in this embodiment, each assessment is set up by creating an answer key for that assessment. At step 260, a command to create a new assessment, entered by selecting a menu item or a toolbar button, is received. The assessment tool 84 then prompts the facilitator to determine if the descriptions of the questions of the assessment are to be manually entered during the creation of the answer key (step 262). If the facilitator selects “yes” at step 262, then the assessment tool 84 presents windows that allow the facilitator to manually create the answer key. If the facilitator selects “no” at step 262, then the assessment tool 84 prompts the facilitator to determine if the assessment is an instant-question assessment (step 266). An instant-question assessment is an assessment that is instantaneously created and delivered to participants, e.g., during a lesson. If the facilitator selects “yes” at step 266, then the assessment tool 84 presents a window that allows the facilitator to create an answer key for the instant-question assessment (step 268). If the facilitator selects “no” at step 266, then the assessment tool 84 prompts the facilitator to determine if a generic answer key is to be created (step 270). A generic answer key is an answer key for an assessment in which all questions are of the same type and have the same correct answer. For example, the facilitator may create a generic answer key of an assessment having ten (10) questions, all of which are of the multiple choice type and have the same number of possible answer choices, such as for example, options “A”, “B”, “C”, and “D”, and have the same answer choice as the correct answer, such as for example option “C”. If the facilitator selects “yes” at step 270, then the assessment tool 84 presents a window that allows the facilitator to create a generic answer key (step 272). If the facilitator selects “no” at step 270, the assessment tool 84 presents a window that allows the facilitator to create an answer key for the assessment without entering question descriptions (step 274).

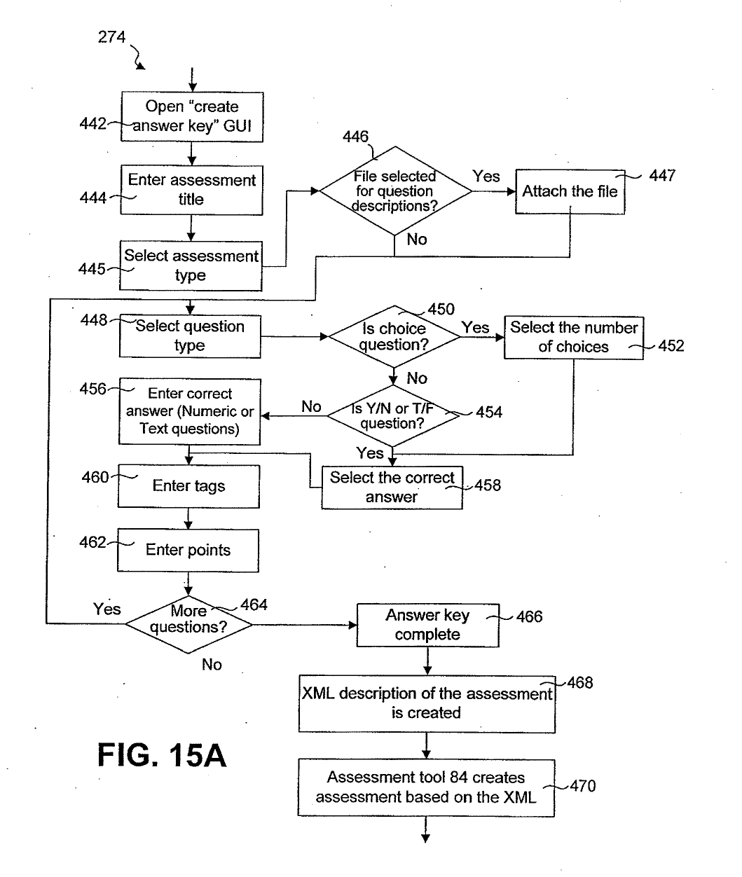

FIGS. 11 to 13B show the windows presented by the assessment tool 84 that allow the facilitator to manually create an answer key during step 264 of FIG. 10. FIG. 11 shows an assessment information entry window 300 that enables the facilitator to enter assessment information. In this embodiment, the assessment information comprises an assessment title, which is entered in a textbox 302; an assessment type, such as for example, Quiz, Exam, Test, or a custom assessment type created by the facilitator, which is entered using dropdown list 304; an assessment subject, such as for example, Mathematics, English, etc., which is entered in a textbox 306; and an assessment topic, which is entered in a textbox 308. Window 300 also comprises an “Add” button 310 which, when selected, causes the assessment tool 84 to present an assessment question type selection window 320.

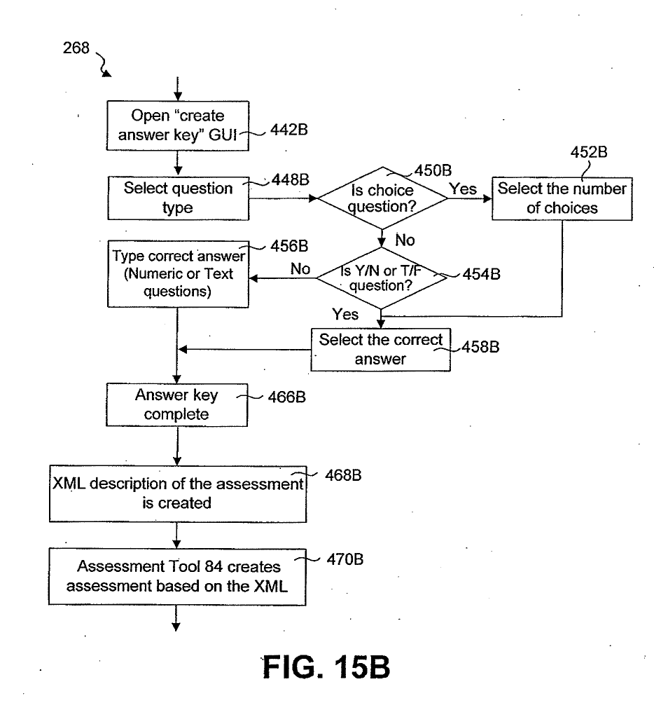

FIG. 12 shows the assessment question type selection window 320, which comprises a plurality of buttons, each of which may be selected for selecting a respective question type. In the embodiment shown, the window 320 comprises a yes/no question type button 322; a multiple choice question type button 324; a number, fraction or decimal question type button 326; a true/false question type button 328; and a multiple answer question type button 330. Window 320 also comprises a “Back” button 332, which can be selected to return to window 300, and a “Next” button 334 which, when selected, causes the assessment tool 84 to present an assessment question description entry window 370.

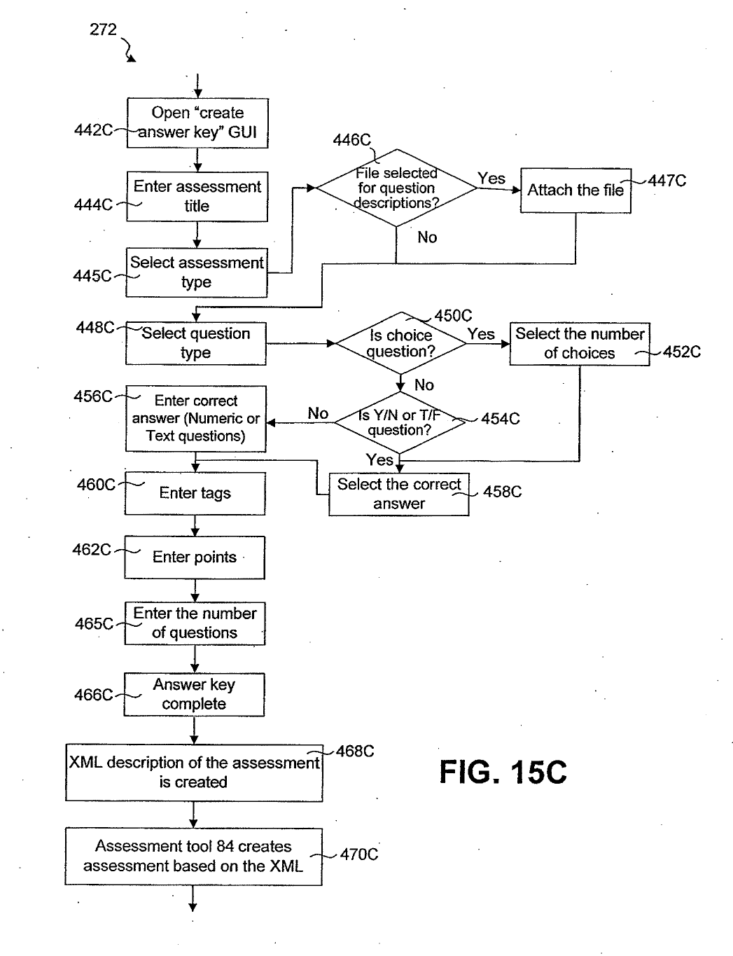

FIG. 13A shows the assessment question description entry window 370. Window 370 comprises a text area 372, in which the facilitator can enter a question description. Window 370 also comprises a text area 374, in which the facilitator can enter tag keywords. Window 370 further comprises a “Back” button 376, which can be selected to return to window 320, and a “Next” button 378 which, when selected, causes the assessment tool 84 to present a correct answer selection and points entry window 384. Window 370 also comprises a “Cancel” button 380, which when selected, cancels creation of the answer key.

FIG. 13B shows the correct answer selection and points entry window 384. Window 384 comprises a plurality of buttons 386 of relevant answer choices, which are based on the question type selected using window 320. Each of the buttons 386 is selectable for allowing the facilitator to enter a correct answer for the question, or to enter multiple correct answers if the question is of the multiple answer question type. The window 384 also comprises a textbox 388 in which the facilitator can enter the number points for the question. Window 384 further comprises a text area 390 in which the facilitator can enter an explanation for the selected answer. The window 384 also comprises an “Insert Another” button 392, which is selectable for allowing the facilitator to enter another question to the assessment. The window 384 also comprises a “Finish” button 396, which can be selected to complete creation of the answer key, a “Back” button 394, which can be selected to return to window 370, and a “Cancel” button 398, which can be selected to cancel creation of the answer key.

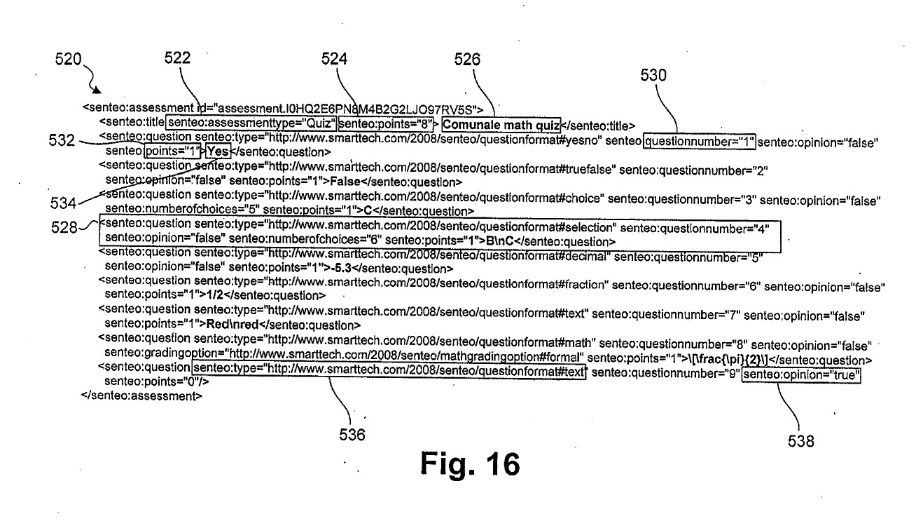

FIG. 14 shows an assessment answer key creation without question description entry window, which is presented by the assessment tool 84 at step 274 of FIG. 10, and which is generally indicated by reference numeral 400. Window 400 allows a facilitator to create an answer key by entering question descriptions provided within a separate electronic document. As mentioned above, the electronic document may be any one of a variety of formats, such as for example, a PDF file, an image file, a text file, a Microsoft Office (e.g., Word, Excel or PowerPoint) file, an OpenOffice file, a webpage, or the like. In this case, the assessment tool 84 presents only a single window 400 which the facilitator uses to enter information for all questions during creation of the answer key for the assessment.

Window 400 comprises an upper portion 402 in which information for the title page of the assessment is entered. Upper portion 402 comprises a textbox 404, in which the assessment title is entered, and a dropdown menu 406, which is used to enter the assessment type, such as for example a quiz, a test, an exam, or a custom assessment type defined by the facilitator. Upper portion 402 also comprises a file browser field 407, which may be used to enter an electronic document containing question descriptions. Window 400 also comprises a lower portion 408 in which the facilitator may enter information for each question. Lower portion 408 comprises a plurality of question type tabs, each of which may be selected to enter a respective question type, and with each tab having a plurality of relevant answer choices associated therewith. In the example shown, the facilitator has selected the multiple choice question type tab 410, which has a scroll box 412 that may be used to enter a number of answer choices for this question. A plurality of buttons 414 corresponding to the entered number of answer choices is displayed adjacent the scroll box 412. Each of the buttons 414 can be selected by the facilitator for entering the correct answer to the question. A button 416 is also displayed, and can be selected by the facilitator to define the question as an opinion question. Opinion questions do not have any correct answer and are not worth any points. A selection box 418 and a textbox 420 are also displayed, and may be used by the facilitator to enter the number of points for the question and to enter tags for question, respectively.

Window 400 also comprises a question list 422, in which an updated list of all of the questions of the assessment is shown in an area 426. Questions are added to the question list 422, and the question and the corresponding correct answer are displayed in the area 426, once button 414 has been selected. The question list 422 comprises a textbox 424, in which a current count of the questions listed in the area 426 is shown. Every third question shown in the area 426 is highlighted to improve readability. A placeholder 428 for the next question to be entered is shown at a default position at the bottom of the area 426. Window 400 comprises an “Insert” button 430, which may be selected to move the placeholder 428 to another position within the area 426. Window 400 also comprises a “Remove” button 432, which can be selected to remove a question selected within the area 426 from the question list 422. Window 400 also comprises a “Done” button 434, which may be selected by the facilitator when the answer key is complete. Upon selection of button 434, the assessment tool saves the answer key as an XML description, and attaches the electronic document containing the question descriptions, and selected using the file browser field 407, to the XML description. Window 400 also comprises a “Cancel” button 436, which can be selected to cancel creation of the answer key.

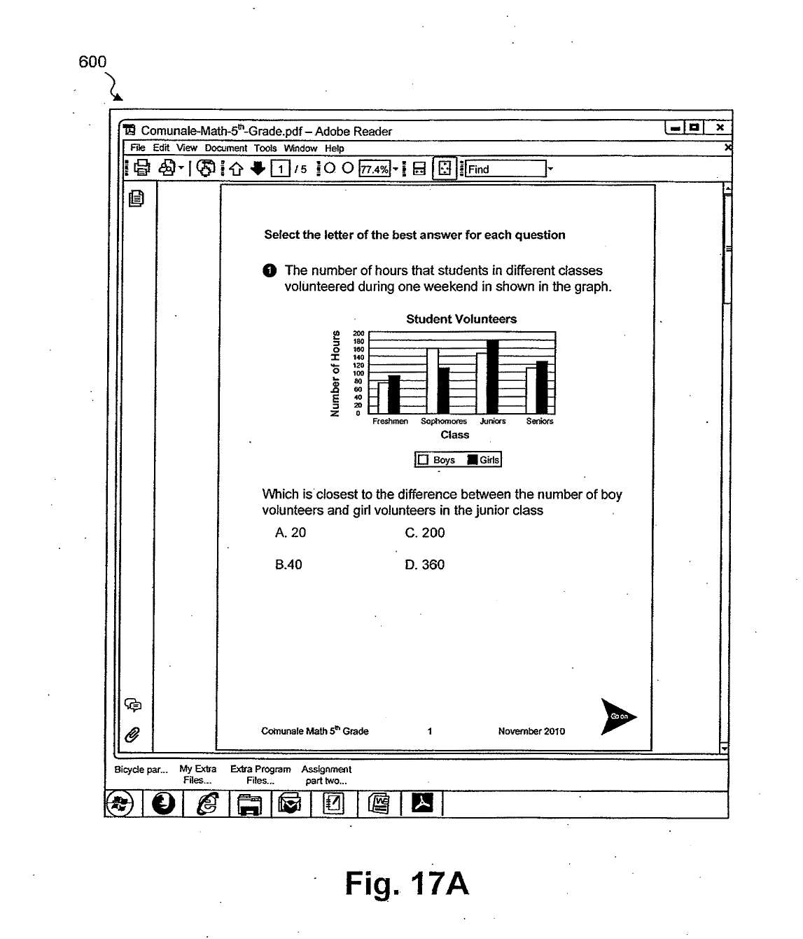

FIG. 15A shows an assessment answer key creation without question description entry process that is carried out during step 274 shown in FIG. 10. The process begins when window 400 is presented by assessment tool 84 upon “no” being selected at step 270 (step 442). The assessment title is then entered (step 444), after which the assessment type is entered (step 445). The assessment tool 84 then checks to determine if the facilitator has entered an electronic document containing descriptions (step 446) using the file browser field 407 of the window 400. If so, the assessment tool 84 attaches the selected electronic document to the assessment (step 447). The facilitator then selects the question type of the first question (step 448). If the question is a multiple choice type (step 450), then the facilitator enters the number of answer choices (step 452). If the question is a yes/no type or a true/false type (step 454), then the facilitator enters the correct answer (step 458). Otherwise, if the question is a numeric type or a text type, then the facilitator enters the correct answer (step 456). The facilitator can then enter the tags for the question (step 460). The facilitator then enters the number of points for the question (step 462). The facilitator can then decide whether to add more questions (step 464). If more questions are to be added, then steps 448 to 462 are repeated for each additional question. If no more questions are to be added, then the facilitator completes creation of the answer key by selecting the button 434 in window 400 (step 466). In response, the assessment tool 84 saves the answer key as an XML description (step 468). The assessment tool 84 then uses the XML description to create an assessment (step 470).

FIG. 15B shows an instant assessment answer key creation process, which is carried out during step 268 shown in FIG. 10. The steps performed in this process are a subset of the process steps carried out during step 274, and illustrated in FIG. 15A. For ease of description, each step shown in FIG. 15B is identified by the same numeral of the corresponding step in FIG. 15A and suffixed by letter “B”.

Instant-question assessments do not require the facilitator to provide detailed assessment information. Once an answer key creation window has been presented (step 442B), the facilitator enters a question type (step 448B). If the facilitator enters a multiple choice question type (step 450B), the facilitator selects the number of answer choices (step 452B), and the process proceeds to step 458B. If at step 450B, the entered question type is not a multiple choice question type, the assessment tool 84 checks whether it is a yes/no question type or a true/false question type (step 454B). If the question is a yes/no question type or a true/false question type, the facilitator enters a correct answer (step 458B), and the process proceeds to step 466B. If at step 454B, the question is neither a yes/no question type nor a true/false question type, then the facilitator enters the correct answer (step 456B) and the process proceeds to step 466B. Creation of the instant assessment answer key is complete when the button 434 of the window is selected (step 466B). Once button is selected, the assessment tool 84 saves the answer key as an XML description (step 468B), and then uses the XML description to create the assessment (step 470B).

FIG. 15C shows a generic answer key creation process, which is carried out during step 272 shown in FIG. 10. The steps performed here are similar to those illustrated in FIG. 15A. For ease of description, each step shown in FIG. 15C that is same as in FIG. 15A is identified by the same numerals suffixed by a letter “C”.

Once the window 400 is presented by assessment tool 84 (step 442C), the facilitator enters the assessment title (step 444C), and enters the assessment type (step 445C). The assessment tool 84 then checks to determine if the facilitator has entered an electronic document containing descriptions (step 446C), using the file browser field 407 of the window 400. If so, the assessment tool 84 attaches the selected electronic document to the assessment (step 447C). The facilitator then enters the question type (step 448C). If the question is a multiple choice type (step 450C), then the facilitator enters the number of answer choices (step 452C). If the question is a yes/no type or a true/false type, then the facilitator enters the correct answer choice (step 458C). Otherwise, if the question is a numeric type or a text type, then the facilitator enters the correct answer (step 456C). The facilitator can enter the tags for the questions (step 460C). The facilitator then enters the number of points for the questions (step 462C). The facilitator then enters the total number of questions in the assessment (step 465). After the facilitator selects a “Done” button (not shown) to complete creation of the answer key (step 466C), the assessment tool 84 saves the answer key as an XML description (step 468C), and then uses the XML description to create the assessment (step 470C).

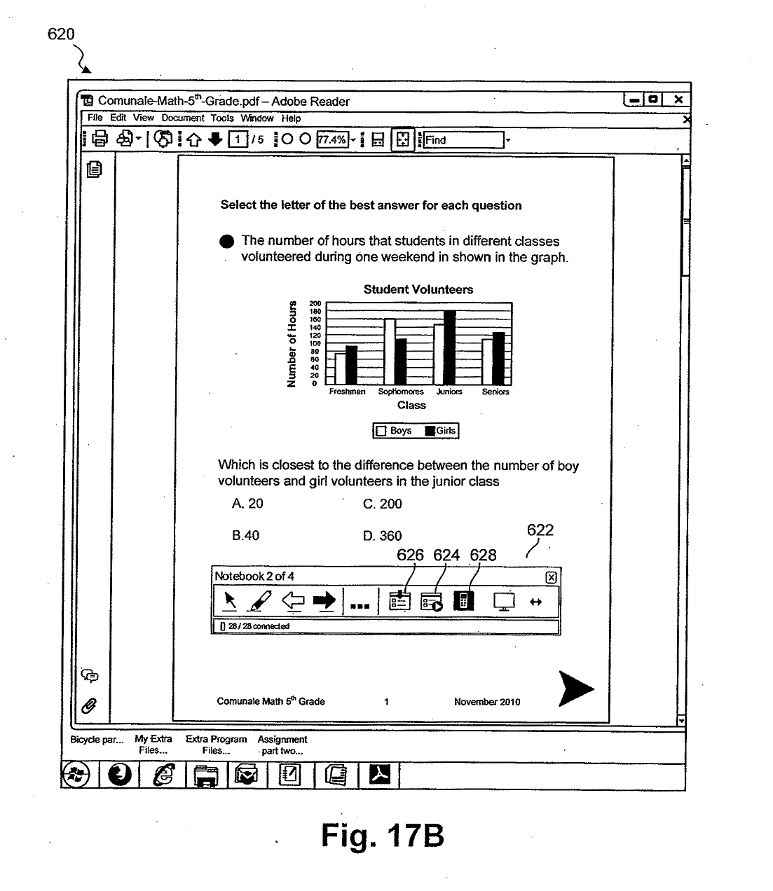

FIG. 16 shows an exemplary XML description of an answer key, and which is generally indicated by reference numeral 520. Selected strings 522 to 538 of the XML description 520 are described herein for explanatory purposes. String 522 defines the assessment type, as entered by the facilitator. String 524 defines the total points available for the assessment, while string 526 defines the assessment title. Strings of the XML description beginning with the keywords “senteo:question” and enclosed within the symbols “<” and “>”, such as for example string 528, are question strings about a specific question. Within each question string are shorter strings that define information about the question. For example, sub-string 530 defines the question number; sub-string 532 defines the points for the question; string 534 defines the question number; string 536 defines the question type; and string 538 defines whether or not the question is an opinion question.

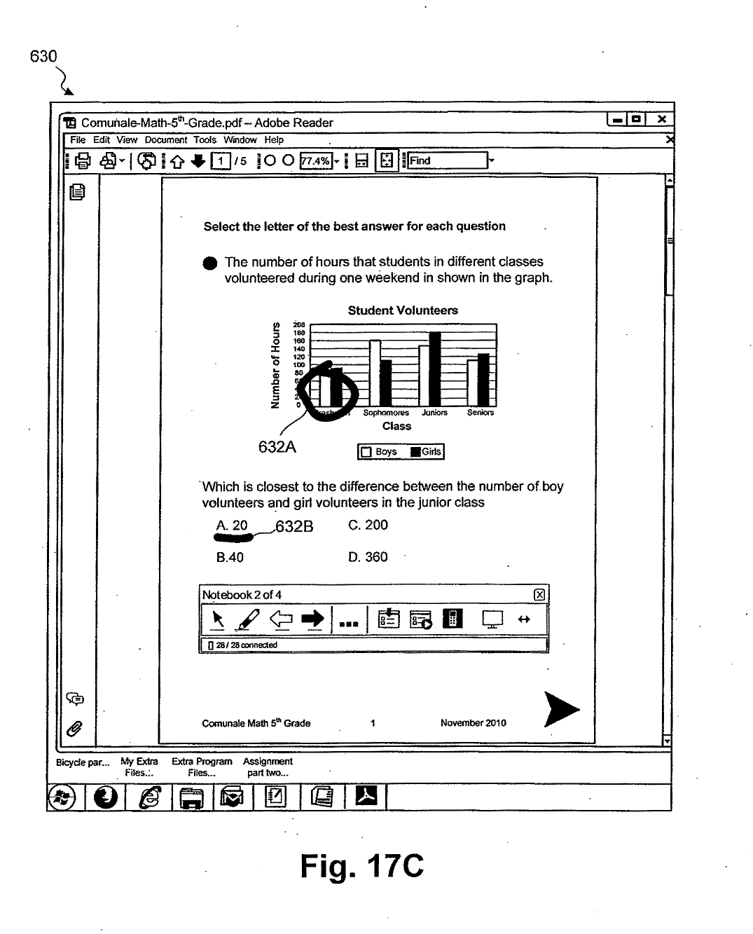

As described above, the assessment tool 84 allows the facilitator to create an answer key without entering question description, and to obtain the question descriptions from another electronic document. FIG. 17A shows an exemplary electronic document comprising a question description and displayed using Adobe® Acrobat Reader, and which is generally referred to using reference numeral 600. To conduct an assessment, the facilitator starts the assessment tool 84, which in this embodiment is the SMART Notebook™ software, and launches the transparent mode available therein. The transparent mode allows a transparent window to be overlaid on content displayed on the interactive surface 34 and/or on the desktop presented on a display screen of the general purpose computing device 16. Upon launching the transparent mode, a transparent mode toolbar 622 is displayed, as shown in FIG. 17B. Transparent mode toolbar 622 comprises an assessment start button 624 that is selectable for starting the assessment session, a button 626 that is selectable for inserting questions in the assessment, and a button 628 that is selectable for opening a toolbar (not shown) comprising function buttons for monitoring the response devices 26 and progress of the assessment. Those of skill in the art will appreciate that the transparent mode toolbar 622 shown in FIG. 17B is exemplary, and that the toolbar may alternatively include other buttons.

During the assessment session, the facilitator can inject digital ink annotations on the electronic document. For example, FIG. 17C shows exemplary digital ink annotations 632A and 632B made on the question description within the electronic document 600. Such digital ink annotations may be used for facilitating understanding of the question description by the participants, for example.

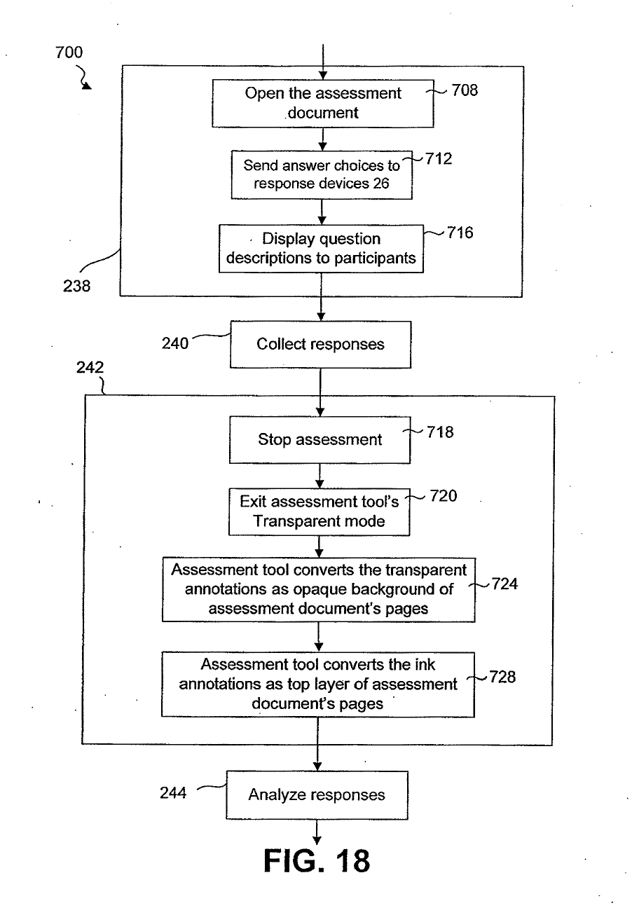

FIG. 18 shows a process for conducting an assessment, during steps 238 to 244 of process 210, using the transparent mode of the assessment tool 84, and which is generally indicated using reference numeral 700. Process 700 begins when the assessment document, which in this embodiment is a SMART Notebook™ file, is opened (step 708). During this step, the assessment tool 84 displays the title page of the assessment, opens the electronic document containing question descriptions, and launches the transparent mode of the assessment tool 84. Additionally, during this step, the assessment tool 84 takes a screen shot of all question description pages in the electronic document, and saves these screen shots as transparent annotations to corresponding pages in the assessment. For example, a question description on page number five (5) in the electronic document is saved to page number five (5) of the assessment.

The assessment tool 84 then sends the answer choices for the questions in the assessment to the response devices 26 (step 712). In this embodiment, the answer choices for all of the questions are sent to all of the response devices 26 generally simultaneously once the assessment starts. In this manner, the response devices 26 receive the sent answer choices at the beginning of the assessment session, allowing the participants to respond to the questions at their own pace. The participants may answer the questions in random sequences. The assessment tool 84 then displays the question descriptions to the participants (step 716). The process then proceeds to step 240 shown in FIG. 9, during which the participants enter responses to the questions using the response devices 26 and the responses are transmitted to the general purpose computing device 16. When the assessment is finished, the facilitator ends the assessment (step 718) by selecting the assessment start button 624 of the transparent mode toolbar 622. In response, the assessment tool 84 exits the transparent mode (step 720). The assessment tool 84 converts the transparent annotations, namely the screen shots of all question description pages, as opaque backgrounds (step 724). If the facilitator has injected digital ink annotations on the question descriptions during the assessment, the assessment tool 84 converts those digital ink annotations as top layers of corresponding pages of the assessment (step 728). As will be understood, once step 728 has been completed, the assessment will contain all question descriptions that were originally present in the external document, as well as any digital ink annotations thereon. The facilitator can then refer to this assessment during analysis of the received responses, such as during step 244 of process 210 (shown in FIG. 9).

Variations of the embodiments described above are possible. For example, those skilled in the art will appreciate that in an alternative embodiment, the window 400 may comprise a different set of question types, and/or it may provide the facilitator with the flexibility to create customized question types.

In some alternative embodiments, during an assessment session, a time limit may be set for each question. In this case, each question is sent to the response devices when the time limit for answering the current question expires. In some other embodiments, each question is sent to the response devices when at least a predefined percentage of the participants (e.g., 80%) have submitted the answers to the current question. Those skilled in art will appreciate that other schemes of delivering the assessment questions to participants may alternatively be used.

Although in embodiments described above, every third question shown in the area is highlighted to improve readability, in other embodiments, other questions shown in the area may be alternatively be highlighted.

In another alternative embodiment, the instant-question assessment may comprise an opinion question. As mentioned above, opinion questions do not have any correct answer, and are used to poll participants to get feedback. In this embodiment, the facilitator does not enter any correct answer while creating the answer key.

In another alternative embodiment, the facilitator alternatively need not attach the external document containing question descriptions with the answer key using the file browser field in the window 400. Rather, the user may alternatively manually open the external document at step 708 of process 700, and then launch the transparent mode before starting the assessment by selecting the assessment start button on transparent mode toolbar. In this case, the facilitator manually displays question descriptions by scrolling through the pages of the electronic document. In this embodiment, the questions in the electronic document are displayed synchronous with the assessment i.e., the question description is displayed before moving to the assessment page for the same question. As will be appreciated, this allows the transparent annotations and digital ink annotations to appear in the correct page of the assessment.

According to another embodiment, the transparent mode toolbar may alternatively comprise a button that is selectable for taking screen shots of the electronic document. In this embodiment, the assessment tool will not automatically take the screen shots of the electronic document. The facilitator will decide if and when to capture the question descriptions in the electronic document and save them to the assessment.

In the embodiments described above, the response devices do not receive the screen shots of the question descriptions when those descriptions are contained in an external document. According to an alternative embodiment, the response devices may receive the screen shots of the question descriptions, along with the possible answer choices.

According to another embodiment, the participant response system may alternatively be used in combination with other software applications such as for example, the Sync™ software offered by the SMART Technologies ULC. Sync™ is classroom collaboration software that is offered in two variations, the Teacher edition and the Student edition for both the Windows® and the Mac® operating systems. In this embodiment, the facilitator will share the desktop of the teacher computer running SynC™ Teacher edition with the student computing devices running the Sync™ Student edition to deliver the assessment content.

As will be understood, the configurations of the host-side and client-side applications are not limited to those described above and in other embodiments, other configurations of the host-side and client-side applications may be used. For example, the host-side application 142 may reside and run on one or more servers, and may communicate with each other through a network. As another example, any of the assessment tool and the management module may alternatively be web applications running on one or more servers, and may provide one or more GUIs to the facilitator via a web browser on a computing device used by the facilitator. Similarly, the client-side application may alternatively also be a web application that runs on one or more servers, and may provide a GUI to each participant via a web browser on each participant's response device. As a further example, both host-side and client-side applications may be web applications that run on one or more servers, and may provide one or more GUIs to the facilitator and participants via a web browser running on their computing devices.

Although in embodiments described above, the response devices 26 comprise remote units and laptop computers, in other embodiments, the response devices may alternatively comprise any computing device, such as, for example, remote units, tablet computers, smartphones, and/or personal digital assistants (PDAs). Here, the smartphones and/or PDAs would be connected to the general purpose computing device wirelessly via the transceiver or via other, commercial wireless transceiver such as wireless routers, or via wired means such as for example Ethernet or Internet. In a related embodiment, the client-side application is implemented as a software application running on the smartphones and/or the PDAs.

Although embodiments have been described above with reference to the accompanying drawings, those of skill in the art will appreciate that variations and modifications may be made without departing from the scope thereof as defined by the appended claims.

What is claimed is:

1. A computerized method comprising:
creating an answer key for an assessment comprising one or more questions to be delivered to one or more participants, the answer key comprising assessment information and question information;
delivering the assessment to said participants;
collecting responses from said participants; and
saving question descriptions, any annotations made thereon and the collected responses.

2. The method of claim 1 wherein the assessment information comprises at least one of an assessment title, an assessment type, an assessment subject and an assessment topic.

3. The method of claim 2, wherein said creating further comprises:
entering at least one of said assessment title, said assessment type, said assessment subject and said assessment topic.

4. The method of claim 1, wherein the question information comprises at least one of a question type, points, tags and a correct answer of each question in the assessment.

5. The method of claim 4, wherein said creating further comprises:
entering at least one of said question type, said points, said tags and said correct answer for each question.

6. The method of claim 1, further comprising:
deriving said question descriptions from at least one electronic document.

7. The method of claim 6, further comprising:
displaying said question descriptions.

8. The method of claim 6, further comprising:
saving the created answer key as an XML description.

9. The method of claim 8, further comprising:
attaching said at least one electronic document to said XML description.

10. The method of claim 6, wherein said at least one electronic document is selected from the group comprising a PDF document, an image document, a text document, a Microsoft Office document, an OpenOffice document, and a webpage.

11. The method of claim 7, further comprising:
overlaying a transparent layer configured to receive annotations over the displayed question descriptions.

12. A response system comprising:
a plurality of response devices; and
processing structure communicating with the response devices and executing program code for conducting an assessment, the processing structure being configured to:
create an answer key for the assessment, the answer key comprising assessment information and question information;
deliver the contents of the assessment to response devices;
receive responses from response devices; and
cause question descriptions and any annotations thereon to be displayed.

13. The response system of claim 12, wherein the assessment information comprises at least one of an assessment title, an assessment type, an assessment subject and an assessment topic.

14. The response system of claim 13, wherein said processing structure is further configured to:
receive entry of at least one of said assessment title, said assessment type, said assessment subject and said assessment topic.

15. The response system of claim 12, wherein the question information comprises at least one of a question type, points, tags and a correct answer of each question in the assessment.

16. The response system of claim 15, wherein said processing structure is further configured to:
receive entry of at least one of said question type, said points, said tags and said correct answer for each question.

17. The response system of claim 12, wherein said processing structure is further configured to:
derive said question descriptions from at least one electronic document.

18. The response system of claim 17, wherein said processing structure is further configured to:
display said question descriptions derived from said at least one electronic document.

19. The response system of claim 17, wherein said processing structure is further configured to:
save the created answer key as an XML description.

20. The response system of claim 19, wherein said processing structure is further configured to:
attach said at least one electronic document to said XML description.

21. The response system of claim 17, wherein said at least one electronic document is selected from the group comprising a PDF document, an image document, a text document, a Microsoft Office document, an OpenOffice document, and a webpage.

22. The response system of claim 18, wherein said processing structure is further configured to:
overlay a transparent layer configured to receive annotations over the displayed question descriptions.

23. A non-transitory computer-readable medium storing computer executable instructions, which when executed by processing structure, cause an apparatus at least to:
create an answer key for an assessment comprising one or more questions to be delivered to one or more participants, the answer key comprising assessment information and question information;
deliver the assessment to said participants;
collect responses from said participants; and
save question descriptions, any annotations made thereon and the collected responses.
